(19) United States
(12) Patent Application Publication
(10) Pub. No.: US 2012/0067295 A1
(43) Pub. Date: Mar. 22, 2012

(54) DEVICE AND METHODS FOR DETERRING SQUIRRELS

(75) Inventor: Teresa L. Muckala, Mounds View, MN (US)

(73) Assignee: Muckaluck Enterprises LLC, New Brighton, MN (US)

(21) Appl. No.: 13/206,722

(22) Filed: Aug. 10, 2011

Related U.S. Application Data
(60) Provisional application No. 61/385,009, filed on Sep. 21, 2010.

(51) Int. Cl. A01K 29/00

(52) U.S. Cl. 119/712

(57) ABSTRACT

A device and methods of using the device to deter squirrels from accessing an elevated location such as a bird feeder or birdhouse. The device includes an exposed coiled spring that surrounds the supporting pole, stick, wire or string. The coil is exposed, with no structure (e.g., a tube, cylinder, etc.) covering at least the bottom of the coil, preferably the entire length of the coil. When the device is on pole and a squirrel jumps on it as it attempts to climb, the coiled spring collapses under the weight of the squirrel, dropping it back to the ground. When the device is hung above a bird feeder around the support and a squirrel attempts to descend to the feeder, the coiled spring collapses under the squirrel's weight, stretching the squirrel's body and causing it to pull itself back up to the tree branch.

### CROSS REFERENCE TO RELATED APPLICATION

This application claims the benefit of U.S. Provisional application No. 61/385,009 filed Sep. 21, 2010 entitled “DEVICE AND METHODS FOR INHIBITING SQUIRRELS”, the entire disclosure of which is incorporated herein.

### FIELD OF THE INVENTION

This invention generally relates to a device for inhibiting access by squirrels, for example, to birdhouse and bird feeders.

### BACKGROUND OF THE INVENTION

The fight against squirrels in bird feeders is a never-ending challenge for some bird lovers. Squirrels are notorious for gaining access to bird feeders and to birdhouses no matter what type of preventative device is tried. Numerous attempts have been made to discourage squirrels from accessing elevated bird feeders and birdhouses, such as saucer-shaped plates positioned either below or above the feeder or house, and domes positioned above the feeder or house. Intricate designs that include a plurality of sliding nested pipes have been attempted. Greasing the wire or pole supporting the feeder or house is also known to not always be successful.

Various attempts have also been made to inhibit squirrels from accessing the bird feed, once the bird feeder has been reached. Many bird feeder designs utilize a spring-loaded perch, which can support the weight of a bird, but collapses under the weight of a squirrel. Some bird feeders provide an electric shock to the squirrel or spin after access has been gained, providing a great source of amusement for any onlooker.

There has to be a better way to inhibit squirrels from gaining access to bird feeders and to birdhouses.

### BRIEF SUMMARY OF THE INVENTION

This invention is directed to a device and methods of using the device to inhibit, deter, and preferably prevent, squirrels from accessing an elevated location such as a bird feeder or birdhouse. The device includes an exposed coiled spring that is attached to the support mechanism of the location, the support mechanism usually being a pole, stick, wire or string. When installed properly, the coiled spring surrounds the support mechanism. The coil is exposed, with no structure (e.g., a tube, cylinder, etc.) covering at least the bottom of the coil, and preferably the entire length of the coil.

When the coil device is hung on around pole supporting a bird feeder and a squirrel jumps on it as it attempts to climb, the coiled spring collapses under the weight of the squirrel, dropping it back to the ground. When the coiled device is hung above a bird feeder around the support mechanism and a squirrel attempts to descend to the feeder, the coiled spring collapses under the squirrel's weight, stretching the squirrel's body and causing it to pull itself back up to the tree branch. In both embodiments, the recoil action of the coiled spring device frightens the squirrel to further avoid the bird feeder.

In one particular embodiment, this disclosure provides a kit for deterring squirrels and other critters. The kit includes a coil and an attachment mechanism. In some embodiments, the attachment mechanism is one or two zip-ties. The coil may be metal.

In another particular embodiment, this disclosure provides a method of inhibiting or deterring access to an elevated location mounted on a pole. The method includes providing a coil having a first end and a second end, mounting the first end below the elevated location with the coil exposed around the pole, and letting the coil hang in a relaxed state around the pole with at least the second end of the coil exposed. The first end of the coil may be attached to the location being protected or to the pole. The second end of the coil may hang freely. In some embodiments, the entire coil may be exposed.

### BRIEF DESCRIPTION OF THE DRAWING

The invention may be more completely understood in consideration of the following detailed description of various embodiments of the invention in connection with the accompanying drawing, in which:

FIG. 1 is a schematic illustration of a birdhouse positioned on a pole with the squirrel inhibiting device operably mounted on the pole;

FIG. 2 is a schematic illustration of two bird feeders positioned on a Shepard's hook with the squirrel inhibiting device operably mounted on the Shepard's hook;

FIG. 3 is a schematic illustration of a bird feeder suspended by a wire from a tree with the squirrel inhibiting device operably mounted on the wire; and

FIG. 4 is a schematic illustration of a kit including the squirrel inhibiting device and at least one mounting mechanism.

### DETAILED DESCRIPTION OF THE INVENTION

The present invention is a device to deter or inhibit access to an elevated location (such as a bird feeder, birdhouse or bird bath) to vermin such as squirrels. Although the description of this invention is directed to inhibiting access to squirrels, it is understood that this device can also be used to inhibit access by cats, skunks, opossums, raccoons, rats, mice, and other smaller vermin. Overall, it could be said that this invention is directed to deterring access to an elevated location to critters.

In the following description, reference is made to the accompanying drawing that forms a part hereof and in which are shown by way of illustration various specific embodiments. The description provides additional specific embodiments. It is to be understood that other embodiments are contemplated and may be made without departing from the scope or spirit of the present invention. The following Detailed Description, therefore, is not to be taken in a limiting sense. While the present invention is not so limited, an appreciation of various aspects of the invention will be gained through a discussion of the examples provided below.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

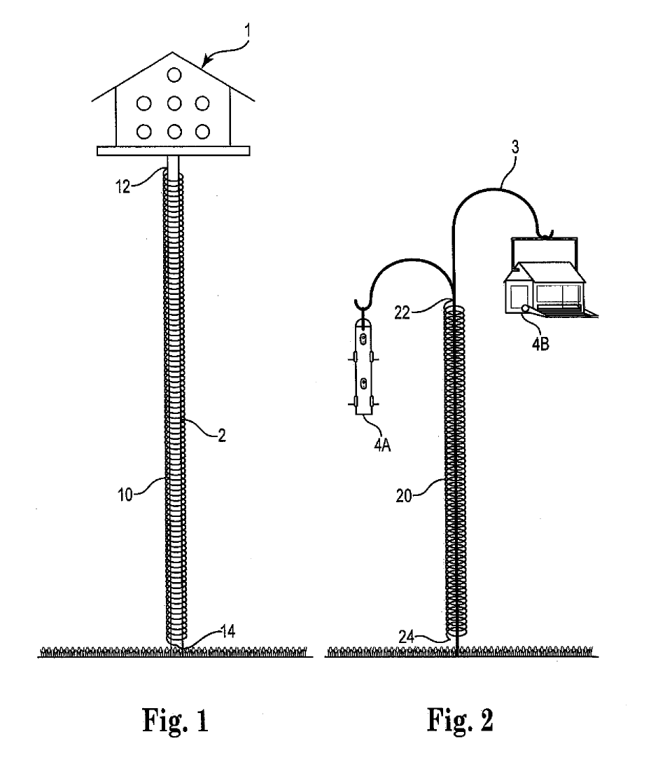

FIG. 1 illustrates a birdhouse 1 mounted in an elevated position (i.e., above the ground) via pole 2. A coiled squirrel inhibiting device 10 is attached below birdhouse 1 around pole 2. Device 10 has a first end 12 and a second end 14 that have therebetween a plurality of coils. Device 10 is mounted to pole 2 below birdhouse 1, in the illustrated embodiment just below the level of birdhouse 1. In other embodiments, device 10 may be connected to birdhouse 1. Device 10 is positioned around pole 2 so that pole 2 extends through device 10 and the coils spirally wrap around pole 2. At least second end 14 is exposed; that is, at least second end 14 is not covered by any structure (e.g., a tube, cylinder, sleeve, etc.). Preferably, at least the lower half of device 10 is exposed, more preferably at least the lower three-quarters of device 10. In some embodiments, at least the lowest 6 inches of device 10 is exposed, and in other embodiments at least the lowest 12 inches of device is exposed. As illustrated in FIG. 1, the entire length of device 10 is exposed.

In its compressed state, that is, with ends 12, 14 pushed together to minimize the distance between adjacent coils, device 10 has a length usually about 2 to 3 inches (e.g., about 2.5 inches) but may be about 1 to 5 inches. In its relaxed extended state (i.e., extended merely due to gravity, with no other forces extending device 10), device 10 may be about 2 feet to 4 feet, although the extended length is highly dependent on the spring constant of device 10, which is a function of the material of device 10, the thickness of the material, the number of coils, the diameter of the coils, etc. The diameter of device 10, in its compressed state is usually about 2 to 3 inches (e.g., about 2.5 inches), although larger or smaller devices 10 would be useful, depending on the support (e.g., pole 2) around which device 10 is positioned. In an extended state (either a relaxed extended state or a forced extended state), the diameter will be generally the same as in its compressed state, but may decrease slightly due to elongation of the coil. In most embodiments, the diameter of device 10 is constant from first end 12 to second end 14 when device 10 is in its compressed state.

Device 10 may be made from any suitable material such as metal, plastic, composite materials, or the like, although metal is the preferred material as it will withstand the rigors of being installed outdoors in extreme temperatures (cold and hot), is resistant to UV degradation, and depending on the specific metal, may be resistant to rusting. A metal device 10 is also preferred as it will typically be free of minute topography onto which a squirrel could cling.

Device 10 inhibits access to birdhouse 1 via pole 2 by multiple manners. When installed to protect a location, device 10 hangs in a relaxed extended state, preferably with second end 14 unconnected and hanging freely above the ground. Further, at least second end 14 and in most embodiments the entire length of device 10 is exposed. Upon a squirrel touching device 10, device 10 will move, often scaring the squirrel away or at least away from device 10. The contact by the squirrel will cause device 10 to swing, rotate, and/or stretch. Additionally, if the movement of device 10 does not sufficiently deter the squirrel and the squirrel attempts to climb up device 10, device 10 stretches under the squirrel's weight to a forced extended state, both scaring the squirrel and deterring vertical climbing by the squirrel. As the squirrel attempts to climb higher up device 10, the coils of device 10 continue to stretch, inhibiting vertical progress by the squirrel. Further, when the squirrel gives up and releases device 10, device 10 will recoil, hopefully again scaring the squirrel.

The following procedure may be used to install device 10 to protect an elevated location (e.g., birdhouse 1) that is supported via its bottom, e.g., by pole 2, by attaching device 10 to the bottom of the location.

(1) Remove birdhouse 1 or other object from support pole 2 and set aside.

(2) Place the birdhouse's mounting element (e.g., support wire or rod) through the center of the coils of device 10. This is easiest done with device 10 in a compressed state.

(3) Attach upper end 12 of device 10 to the mounting element so that device 10 hangs securely therefrom.

(4) Let lower end 14 of device 10 hang loose around pole 2. With device 10 in its relaxed extended state, lower end 14 preferably does not contact the ground.

(5) Remount birdhouse 1 onto support pole 2.

In an alternate method, step (2) may be to wrap device 10 onto the mounting element until the entire device 10 surrounds it.

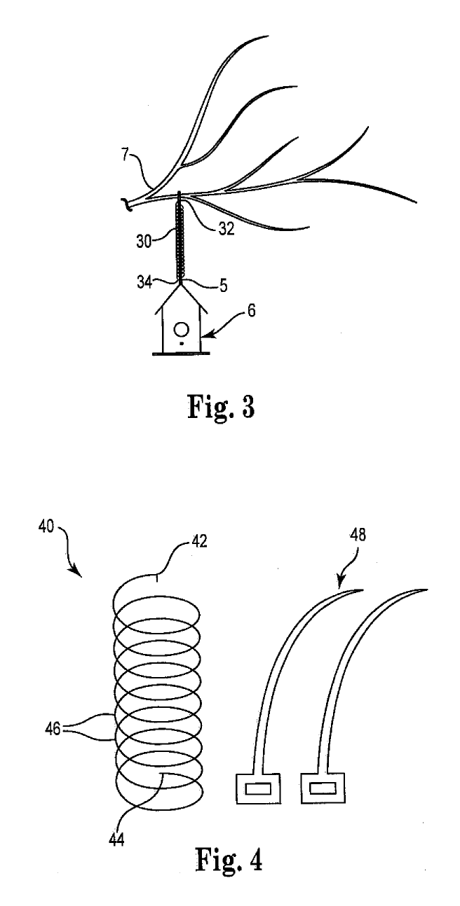

Device 10 may be utilized with various arrangements and with various locations to be protected. FIGS. 2 and 3 illustrate alternate arrangements that benefit having a squirrel inhibiting device.

FIG. 2 illustrates two bird feeders 4A and 4B suspended above the ground on a Shepard's hook 3. A coiled squirrel inhibiting device 20 is attached to and around Shepard's hook 3, which has two separate and spaced apart hanging hooks supported by a pole portion. Device 20 has a first end 22 and a second end 24 that have therebetween a plurality of coils. Device 20 is generally the same as device 10 described above.

The following procedure may be used to install device 20 to protect an elevated location (e.g., bird feeders 4A, 4B) by attaching device 20 to the support that does not have an upper end over which device 20 can be fed (e.g., hook 3).

(1) Manually wind device 20 around Shepard's hook 3 until the entire device 20 surrounds hook 3;

(2) Attach upper end 22 of device 20 to Shepard's hook 3, either on the pole portion or at the joint between the pole portion and the hanging hooks, so that it hangs securely.

(3) Let lower end 24 of device 20 hang loose. With device 20 in its relaxed extended state, lower end 24 preferably does not contact the ground.

In an alternate method, step (1) may be to remove Shepard's hook 3 from the ground and slide device 20 upward around hook 3 so that device 20 surrounds the pole portion of hook 3.

FIG. 3 illustrates a bird feeder 6 suspended and depending from a tree branch 7 via wire 5. A coiled squirrel inhibiting device 30 is attached around wire 5. Device 30 has a first end 32 and a second end 34 that have therebetween a plurality of coils. Device 30 is generally the same as device 10, 20 described above. When device 30 is suspended above the location to be protected, second end 34 is above the level of bird feeder 6, preferably a distance that is uncomfortable for the squirrel to jump, for example, at least 12 inches, such as at least 24 inches.

FIG. 4 illustrates a critter (e.g., squirrel) deterring kit. The kit includes a coiled device 40 and an attachment mechanism 48. Coiled device 40 has first end 42, a second end 44 and a plurality of coils 46 therebetween. Device 40 is generally the same as device 10, 20, 30 described above.

As indicated above, the coiled animal deterrent device 40 may be made from any suitable material such as metal, plastic, composite materials, or the like, although metal is the preferred material as it will withstand the rigors of being installed outdoors in extreme temperatures (cold and hot), is resistant to UV degradation, and may be resistant to rusting. In its compressed state, device 40 has a length (or height, when set on a surface) of about 1 to 5 inches, usually about 2 to 3 inches (e.g., about 2.5 inches), and a diameter of about 2 to 3 inches (e.g., about 2.5 inches), although larger or smaller devices 40 would be useful. In its relaxed expanded state, device 40 has a length of about 2 feet to 4 feet, although the extended length is highly dependent on the spring constant of device 40, which is a function of the material of device 40, the number of coils, the diameter of the coils, etc. One or both ends 42, 44 may include a feature to facilitate connecting attachment mechanism 48 thereto, a feature such as an eyelet, a hook, a slit, a protrusion, or a stop.

Attachment mechanism 48 may be any device suitable for attachment of device 40 to pole 2, Shepard's hook 3, wire 5, or even to birdhouse 1 or a feeder. The attachment mechanism may be, for example, a zip-tie (e.g., plastic zip-tie), metal wire, string, pressure sensitive adhesive, a screw, a nail, or a clip. Mechanism fasteners, such as a nail, screw, clip, are particularly suitable for attaching device 40 (e.g., end 42) directly to the bottom of a metal or wooden structure, such as a birdhouse. Wire or zip-ties are particularly suitable for attaching device 40 to an attachment point such as a joint in a multiple-hook Shepard's hook. Tape or a clip may be best suited for attaching device 40 to a suspended wire. The user of device 40 will be able to determine the best or most convenient attachment mechanism 48 for the application. The particular kit of FIG. 4 includes two plastic zip-ties as attachment mechanism 48. One or both zip-ties may be used to attach device 40.

Thus, embodiments of DEVICE AND METHODS FOR DETERRING SQUIRRELS are disclosed. Various modifications and alterations of this invention will become apparent to those skilled in the art without departing from the scope and spirit of this invention, and it should be understood that this invention is not to be unduly limited to the illustrative embodiments set forth herein. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A critter deterring kit comprising:
a coil; and
an attachment mechanism.

2. The kit of claim 1 wherein the attachment mechanism comprises a first zip-tie.

3. The kit of claim 2 wherein the attachment mechanism further comprises a second zip-tie.

4. The kit of claim 1 wherein the coil is a metal coil.

5. A critter deterring kit consisting of:
a coil; and
an attachment mechanism.

6. The kit of claim 5 wherein the attachment mechanism is a single zip-tie.

7. The kit of claim 5 wherein the attachment mechanism is two zip-ties.

8. The kit of claim 5 wherein the coil is a metal coil.

9. A method of inhibiting access to an elevated location mounted on a pole, the method comprising:
providing a coil having a first end and a second end;
mounting the first end below the elevated location with the coil exposed around the pole; and
allowing the coil hang in a relaxed state around the pole with at least the second end of the coil exposed.

10. The method of claim 9 wherein the second end of the coil is hanging freely.

11. The method of claim 9 wherein the first end of the coil is attached to the location.

12. The method of claim 9 wherein the first end of the coil is attached to the pole.

13. The method of claim 9 wherein the entire coil is exposed.
